(19) United States
(12) Patent Application Publication
(10) Pub. No.: US 2026/0227307 A1
(43) Pub. Date: Aug. 6, 2026

(54) SMOKE DETECTOR AND METHOD FOR SMOKE DETECTION

(71) Applicant: AMS SENSORS GERMANY GMBH, Jena (DE)

(72) Inventors: David GAMPERL, Hartberg (AT); Frank KRUMBEIN, Windischholzhausen (DE); Kevin JENSEN, Jena (DE)

(21) Appl. No.: 19/147,329

(22) PCT Filed: Jan. 9, 2024
(86) PCT No.: PCT/EP2024/050409

§ 371 Date: Jul. 11, 2025

(30) Foreign Application Priority Data
Jan. 12, 2023 (DE) 10 2023 100 595.2

(51) Int. Cl. G01N 15/075

(52) U.S. Cl. CPC G01N 15/075

(57) ABSTRACT

A smoke detector includes a detector chamber, a number of emitters and at least one optical sensor. The optical sensor is built or realized as a multi-spectral optical sensor. The multi-spectral sensor includes a plurality of spectral filters for a plurality of spectral channels and at least one broadband channel. The plurality of spectral channels can be realized by photodiodes.

### CROSS-REFERENCE TO RELATED APPLICATIONS

The present application is a national stage entry according to 35 U.S.C. § 371 of PCT application No.: PCT/EP2024/050409 filed on Jan. 9, 2024; which claims priority to German Patent Application Serial No.: 10 2023 100 595.2 filed on Jan. 12, 2023; all of which are incorporated herein by reference in their entirety and for all purposes.

### TECHNICAL FIELD

Embodiments of the present disclosure relate to smoke detectors with an emitter and a sensor.

### BACKGROUND

Detecting and differentiating of smoke types is an important topic in smoke detection devices. Accurate and sensitive sensor response is important because it helps save lives and reduces false alarms that are expensive or endanger lives. Approximately 22% of deaths are caused by inactive devices or false alarms. The risk of death in a home structure with working smoke alarms is 55% lower

In general, a known smoke detector or sensor comprises a LED, a photo diode and a chamber. The chamber fixes the diode and receiver and has light traps to prevent direct light beams to the receiver from the internal light source(s) or external interferences.

Smoke is detected if the optical conditions in the smoke chamber are changed. If the LED is in the switched-on status and no smoke (aerosols) is in the chamber, then the diode will get no light if all reflections are suppressed by light traps. But if the LED is switched on and smoke is in the chamber, the diode will receive reflections from the aerosols (it means stray light measurements).

A general behaviour is now that the higher these reflections are, the higher are the counts and the higher the sensitivity and accuracy. Reflections and their sizes are depending on many factors. These are, for example, the Angle between LED and Diode, the type (material—chemical composition, refractive index), size, number of particles, light energy and wavelengths, system speed (frequency) and diode sensitivity and others.

The target of a test should be designed to obtain as much as possible counts per channel from the sensor which represents direct the reflections and not disruptions or deviations. Smoke or the aerosols can be detected as soon as the amount of light reflected exceeds the sensitivity of the sensor. This sensitivity is depending on the used sensor, its setup, and existing disruptions. In other use cases, the sensitivity must be dynamical. As an example, if the sensor should detect very fast smoke in the beginning of fire, the sensor must be very sensitive in the beginning of fire when the aerosols or the clouds are small, few and scattered.

There is an increasing demand for more sensitive sensor systems and for more information such as smoke or no smoke.

Known smoke detection look at blue and IR light via discrete detectors (limited capabilities). Smoke detectors according to prior art perform the wavelength selection on the emitter side. For example, multiple LEDs are used for example blue and IR combined with a discrete photodetector in an optical arrangement, whereby the photodetector detects photons of a broad range of the optical spectrum. More and more detectors and emitters are needed approach standards (up to 3 each for example in the burger test).

The document EP 3 574 530 B1 discloses an arrangement for optical smoke detection according to the two-colour principle, wherein the arrangement comprises a light emitting diode and a photo sensor which is spectrally coordinated therewith. The light emitting diode comprises an LED chip for emitting light in a first wavelength range and a light converter for converting part of the emitted light into light in a second wavelength.

The document U.S. Pat. No. 7,239,387 B2 describes a method for detecting fires according to the scattered light principle, comprising emitting pulsed radiation of first and second wavelengths into a measuring volume, wherein the scattered radiations of the first and second wavelengths are measured on opposite sides of the measuring volume on a same main axis.

### SUMMARY

At least one embodiment of the present disclosure relates to a smoke detector with improved smoke type detection capabilities.

At least one embodiment of the present disclosure relates to a corresponding method for smoke detection.

According to at least one embodiment, a smoke detector comprises a detector chamber, a number of emitters and at least one optical sensor, whereby the sensor is built as a multi-spectral optical sensor.

At least one embodiment of the present disclosure is based on the consideration that not only the detection of the presence of smoke in general, but also the detection of different kinds of smoke is desirable and is part of modern demand on smoke detectors. In known smoke detectors, multiple different wavelength LEDs would be needed causing an extremely difficult optical smoke chamber design.

In accordance with embodiments described herein, these demands can be met and conducted efficiently with a multichannel broadband detector, e.g., by performing the wavelength selection on the detector side. In this way, the smoke detection can be conducted with only one broadband source.

A detector according to one or more embodiments described herein allows for the reduction of the required parts (1 detector, 1 or 2 emitters). The spectral footprint allows to distinguish between different smoke types and reduce false alarms (particle detection+spectral footprint)

In at least one example, the multi-spectral sensor comprises a plurality of spectral filters for spectral channels and at least one broadband channel.

In at least one example, the channels are realized by photodiodes. In at least one example, a channel comprises a photodiode array, an electronic circuit, a storage facility, and a digital interface. The photodiode array comprises a plurality of photodiodes. The electronic circuit is configured to convert the analog signal generated by the respective photodiode into a digital signal. To this end, in at least one example, it comprises a plurality of analog to digital converters (ADCs). The storage facility on a chip is configured to buffer measurement data and is prefer or more general RAM. The digital interface is configured to enable an external host to read-out the measurement data. It is may be realized as an I2C interface. In at least one example, all these components are integrated into a single CMOS device.

In at least one example, the Filter is deposited directly onto the CMOS device (in that case directly onto the PD Array) after the CMOS has been processed. This can enable every photodiode (PD) to see only portion of the light. The technology used is interference filter technology.

In at least one example, the photodiodes are arranged as a photodiode array. In this way, a very compact design of the sensor and of the smoke detector is possible. For each channel, preferably a pixel array of 3×3 or 5×5 pixels is provided.

In at least one example, the at least one broadband channel covers light in the wavelength region between 350 nm and 1000 nm.

In at least one embodiment, the smoke detector comprises between 4 and 20 spectral channels.

In at least one example, the number of emitters comprise a broad-band light source. As the distinction of different smoke types is performed on the sensor side, a broad-band light source can be used to provide a broad wavelength range which covers all frequency bands employed for smoke identification. The broad-band light source can be, for instance, a white LED, an RGB LED inside a single package, a white LED combined with a near-infrared LED inside the system, or a broadband emitter such as an incandescent light source.

The broad-band light source, in at least one example, emits light in the wavelength range between 350 nm and 1000 nm, especially between 350 nm and 700 nm.

In at least one example, the number of emitters comprises at least one narrow-band light source.

The narrow-band light source, in at least one example, emits in the UV and/or IR or NIR range.

In at least one embodiment, for each spectral range two emitters are arranged in the detector chamber. For example, in the detector chamber two broad-band emitters/light sources and two narrow-band IR emitters/light sources are arranged.

In at least one example, the emitters are arranged symmetrically in the detector chamber, which may mean that with respect to a symmetry axis in the detector chamber, the respective emitters are arranged symmetrically on both sides. In this way, independently of the direction into which the smoke enters the detector chamber, scattered light can be detected. Additionally, by this arrangement the sensitivity is increased, as more light is entering the chamber, hence a smaller smoke concentration is needed for detection.

In at least one embodiment, the smoke detector comprises data registers for the respective spectral channels. In at least one example, for each measurement (of which the time span is adjustable, it can for example lie between 50-180 ms, a raw-count value is stored in the respective data register of the storage (for instance the FIFO). Once the storage space is full, a host (MCU) is contacted via an interrupt in order to fetch the data.

In at least one embodiment, the smoke detector is configured to provide a control signal for the respective emitter, especially for setting the intensity of the emitter. In this way, depending on the sensitivity of the sensor, especially of the photodiodes, the intensity of the respective emitter can be set.

With respect to the method, at least one broadband emitter and/or a number of narrow range emitters light is emitted into a detector chamber, and whereby light scattered by smoke particles is sensed by a multi-spectral optical sensor.

Some advantages are as follows. The usage of multi-spectral sensor combined with broadband light sources enables precise selective smoke type detection, e.g., to distinguish flaming wood from flaming plastic from water vapor from cooking smoke. Also, cigarette smoke, e-cigarette smoke and vaporizer smoke can be distinguished. Production-type smoke effects as for example saw dust can be identified.

Interference filter technology allows to deposit multiple spectral filters on a silicon photodetector enabling multi-spectral sensors at a very low cost.

### BRIEF DESCRIPTION OF THE DRAWINGS

At least one embodiment of the present disclosure is described in connection with the drawings. In this drawings,

FIG. 1 shows a smoke detector according to prior art;

FIG. 2 shows a smoke detector according to at least one embodiment of the present disclosure;

FIG. 3 shows a detector chamber of the smoke detector according to FIG. 2;

FIG. 4 shows an electronic layout of a smoke detector in at least one embodiment of the present disclosure;

FIG. 5 shows a further detailed electronic layout of components of the smoke detector according to FIG. 4;

FIG. 6 shows sample curves of detected light in a smoke detector;

FIG. 7 shows sample curves for different smoke types in a wavelength range from 400 nm to 750 nm;

FIG. 8 shows sample curves for different smoke types in a wavelength range from 750 nm to 950 nm; and

FIG. 9 shows a photo diode array of a multi-spectral sensor of smoke detector.

Identical parts are labelled by the same reference signs.

### DETAILED DESCRIPTION

In FIG. 1, a smoke detector 2 according to prior art is shown. The smoke detector 2 comprises a detector chamber 6 in which an emitter 10 and a sensor 14/detector are arranged. Also shown are smoke 26 and a very enlarged smoke particle 30.

The emitter 10 emits light 18 which is reflected by smoke particles 30 into the sensor 14. The emitter 10 is built as one or more narrow-range light sources. The sensor 14 is built as one or more detector elements with matching corresponding wavelength sensitivity with respect to the wavelength(s) of the emitter 10. For instance, if an IR emitter 10 is present, a corresponding IR sensor 14 is present. If additionally, a blue emitter 10 is present, also a sensor 14 for blue radiation is present.

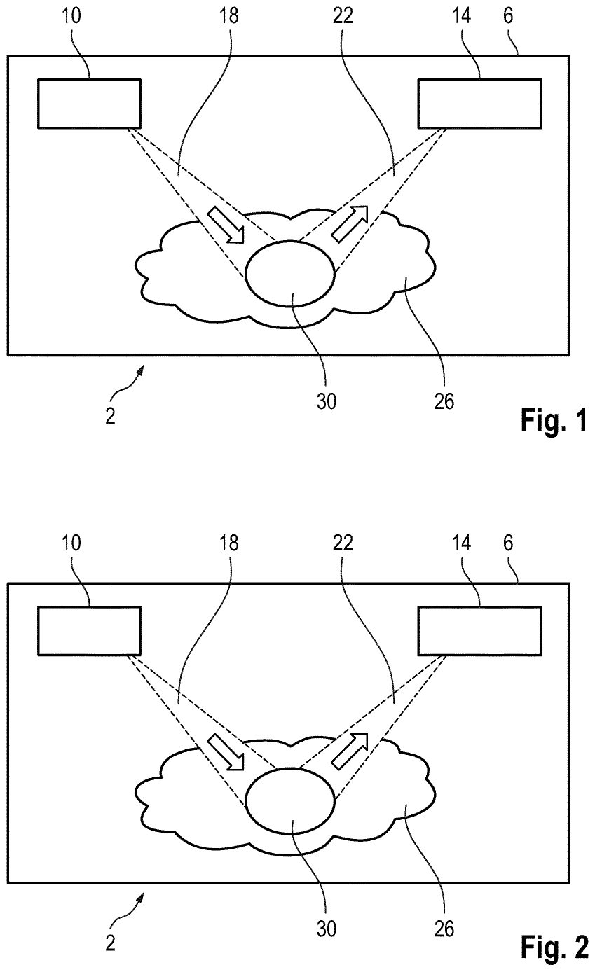

In FIG. 2, a smoke detector 2 according to at least one embodiment of the present disclosure is shown. The emitter 10 is built as a broad-band light source. The sensor 14 is built as multi-spectral optical sensor.

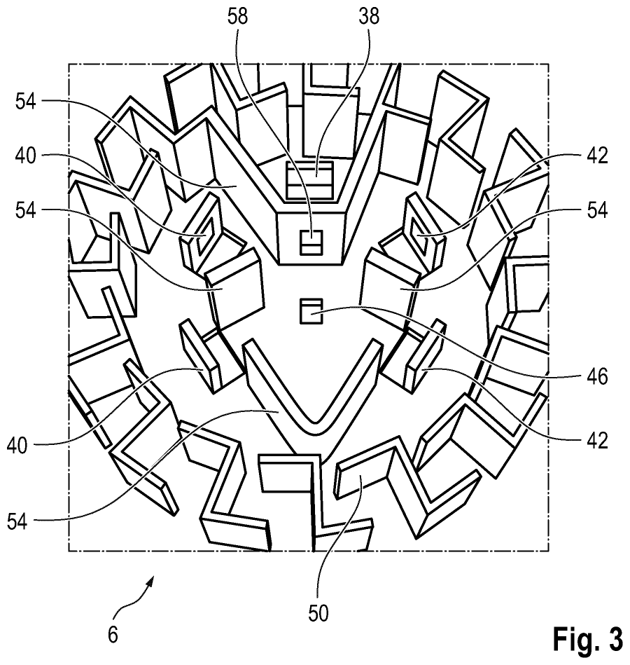

In FIG. 3, a detector chamber 6 of a smoke detector 2 in at least one embodiment is shown. In the detector chamber 6, the multi-spectral optical sensor 38 is arranged. Two visible light emitters 40 and two IR emitters 42 are arranged symmetrically in the detector chamber 6. The emitters 40, 42 are arranged to emit light into a centre 46 of the detector chamber 6. The sensor 38 is arranged to detect light rays which are emitted from emitters 40, 42 and are reflected in the region of the centre 46 by smoke particles.

In the periphery of the detector chamber 6, several z-shaped walls 50 are arranged which prevent ambient light or other light from the outside to enter the centre 46. Further walls are 54 are arranged in the detector chamber 6 which prevents light from outside to reach the centre 46. In one of these walls 54 arranged in front of sensor 38, an opening 58 is arranged allowing light to reach the sensor 38.

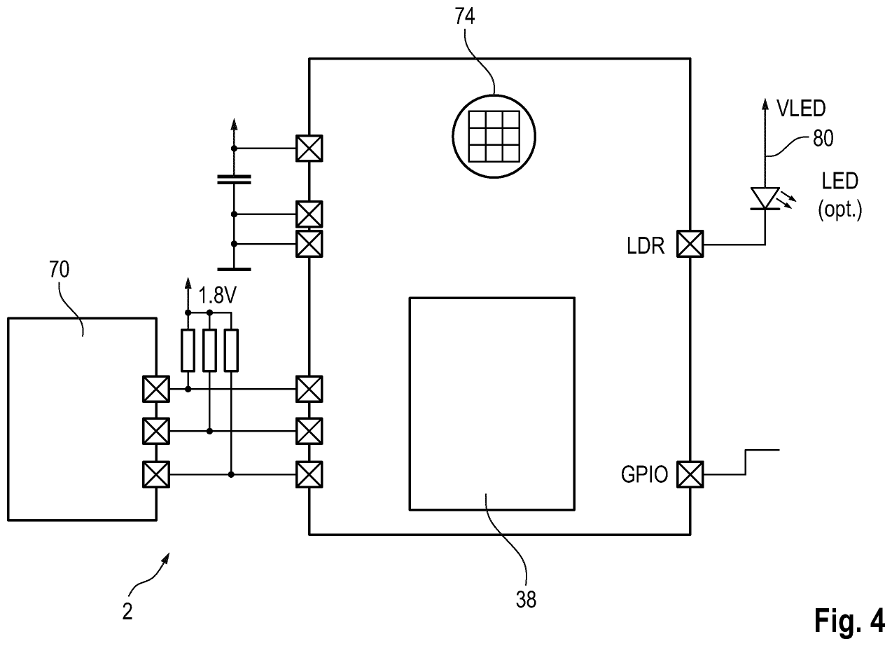

In FIG. 4, an electronic layout of the smoke detector 2 is shown. A microcontroller unit 70 (MCU) is provided for operating the multi-spectral optical sensor 38 which comprises a photodiode array 74. The microcontroller unit 70 is also configured to provide a control signal 80 for at least one emitter 10.

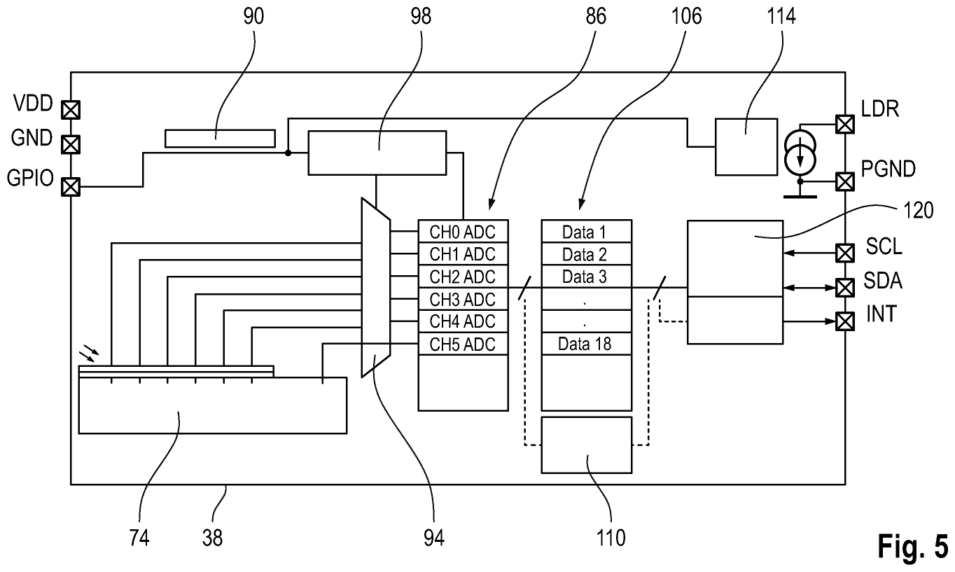

In FIG. 5, the sensor 38 is shown in more detail. In at least one embodiment, the sensor 38 comprises 12 spectral channels which cover the wavelength range from 400 nm to 1000 nm. The sensor 38 comprises 6 spectral channels with corresponding ADCs 86 (analog-digital converters) within the wavelength range 400 nm-1000 nm.

There are furthermore 2 additional general-purpose channels (clear, flicker detection). The sensor 38 comprises a sync input 90, a sample multiplexer or SMUX 94, and an automatic measurement engine 98. The automatic measurement engine 98 is a circuit which automatically switches the photodiodes onto the ADCs 86. This is used as there are 6 ADCs 86, but 25 photodiodes. The switching is therefore performed automatically. The measurement data is then transferred into the storage, especially the FIFO.

The sensor 38 comprises data register 106. For each of the channels 86, 102, a respective 16-bit data register is provided.

The sensor 38 comprises a 256 FIFO (first in first out) storage 110.

The photodiode array 76 comprises a 5×5 PD (photo diode) in chip IF array and a flicker PD.

The sensor 38 is built to drive an emitter 10 which is built as at least one LED. To this end, the sensor 38 comprises an LED driver 114.

The sensor 38 further comprises an I2C (inter-integrated circuit) register 120, for example, with 1 MHz, and an interrupt handling 124. The I2C is an interface enabling the host controller to read out the data. It comprises a clock and a data line SCL/SDA and comprises a specific protocol.

The sensor 38 has an improved outer band suppression of spectral filters and an automatic ADC re-configuration for multichannel read-out. It comprises an improved flicker detection (continuous flicker detection), an increased flicker sensitivity (2nd PD) and a decreased I2C Interface loading (8-bit mode).

The dimensions of the sensor 38 are in at least one example 3.1 mm×2 mm×1 mm.

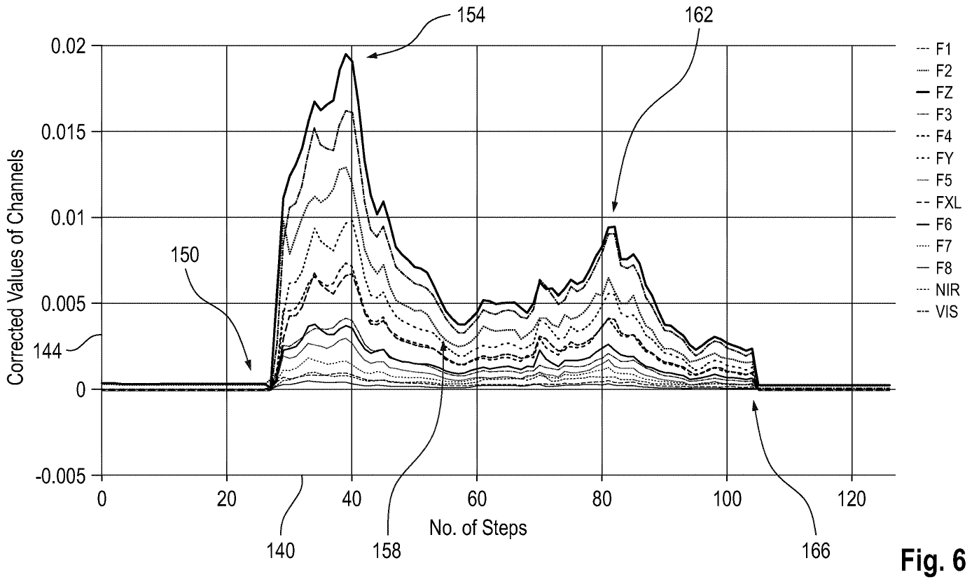

In FIG. 6, in a diagram on the x-axis 140 a number of measurement samples (1 sample per 180 ms) and on the y-axis 144 spectral raw data as an example are plotted. The number of samples on the x-axis 140 is proportional to the time of the data acquisition experiment shown. The different curves correspond to various photo diodes which each have their specific wavelength band in which they are sensitive.

At a first point in time 150, a smoke source is activated or applied, leading to an overall increase of counts in the curves. At a second point in time 154, the smoke source is removed again. At a third point in time 158, the smoke is source is applied again. At a fourth point in time 162, the smoke source is applied again, and at a fifth point in time 166, the remaining smoke is removed from the smoke chamber by airflow.

As can be seen, essentially in all channels a response to the smoke entering the smoke chamber is seen. The different channels react differently to the smoke in the absolute numbers of counts and in the shape of the respective curves. Already from this figure it can be inferred that by considering the information of the channels and analyzing their behaviour, not only the overall presence of some, but the specific type of smoke can be detected.

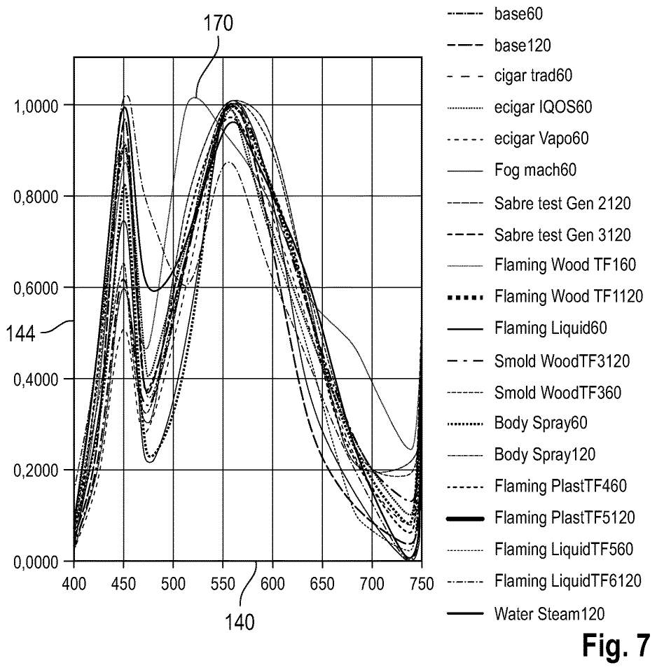

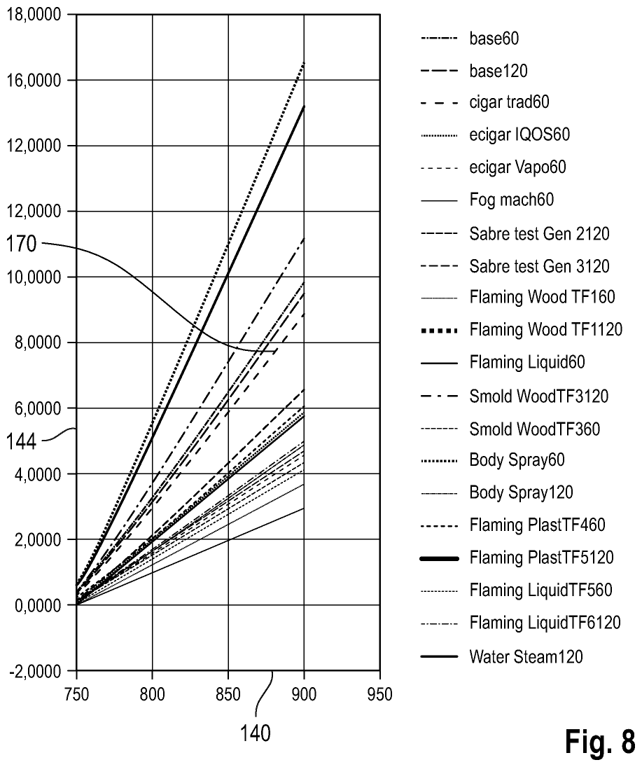

In FIG. 7, in a diagram on the x-axis 140 the wavelength and on the y-axis a relative count number is plotted. The various curves correspond to different smoke sources. For example, a curve 170 corresponds to smoke from an e-cigar. In FIG. 8, the corresponding curves are shown in the wavelength range 750 nm-950 nm, i.e., in the NIR range.

From these two FIGs, it can be inferred that different types of smoke have different characteristics/curves in various wavelength regions. In a smoke detector 2, according to at least one embodiment of the present disclosure, which senses scattered light in a broad range of wavelength, the specific type of smoke can be identified. In this way, steam or cigar or e-cigar smoke can be discriminated from other smoke types which originate from a serious fire.

An example setup for the channels of the multi-spectral optical sensor 38 is shown in the following table which in the first row (“C”) shows channel labels, in the second row (“f”) shows the corresponding frequency of the respective channel in the unit of nanometres, and in the third row shows the full width at half maximum (“FWHM”) in the unit of nanometres.

| C | F1 | F2 | FZ | F3 | F4 | FY | F5 | FXL | F6 | F7 | F8 | NIR |
|---|---|---|---|---|---|---|---|---|---|---|---|---|
| f | 400 | 425 | 440 | 473 | 514 | 555 | 547 | 595 | 635 | 685 | 745 | 850 |
| [nm] | | | | | | | | | | | | |
| FWHM | 30 | 22 | 55 | 30 | 40 | 100 | 35 | 80 | 50 | 55 | 60 | 54 |
| [nm] | | | | | | | | | | | | |

The sensor configuration comprises the 12 spectral filters shown in the table and 2 general purpose broadband channels. The two broadband channels (clear and flicker) do not comprise a filter and can be used for calibration as they sense the spectrum between 400-700 nm.

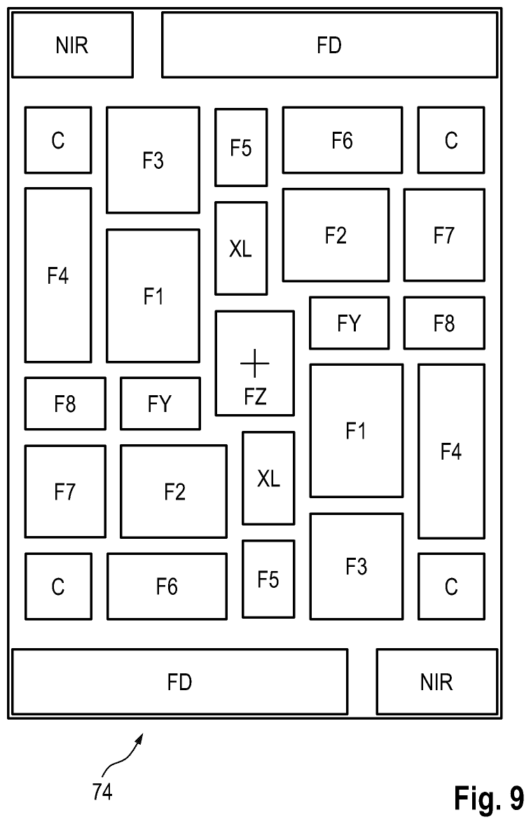

In FIG. 9, an example configuration of a photodiode array 7 of the multi-spectral optical sensor 38 is shown. The spectral sensors of the table above are shown the labels of the tables as well as the photodiodes labelled with “FD” and “C”. The “FD” channel is a broadband channel in the visible light. The “C” channel is a clear channel.

### LIST OF REFERENCE SIGNS

2 smoke detector
6 detector chamber
10 emitter
14 sensor
18 light
22 light
26 smoke
30 smoke particle
34 broad-band emitter
38 multi-spectral optical sensor
40 visible light emitter
42 IR emitter
46 centre
50 wall
54 wall
58 opening
70 microcontroller unit
74 photodiode array
80 control signal
86 channels
90 sync input
94 SMUX
98 automatic measurement engine
106 data registers
110 FIFO storage
114 LED driver
120 I2C Register
124 interrupt handling
140 x-axis
144 y-axis
150 point in time
154 point in time
158 point in time
162 point in time
166 point in time
170 curve

1. A smoke detector, comprising:
a detector chamber;
a number of emitters and at least one optical sensor;
a plurality of spectral channels numbering between 4 and 20 spectral channels, the plurality of spectral channels comprising photodiodes arranged as a photodiode array;
wherein the at least one optical sensor is built as a multi-spectral optical sensor,
wherein the multi-spectral sensor comprises a plurality of spectral filters for the plurality of spectral channels and at least one broadband channel.

2. (canceled)

3. (canceled)

4. (canceled)

5. The smoke detector according to claim 1, wherein said at least one broadband channel is configured to cover light in the wavelength region between 350 nm and 1000 nm.

6. (canceled)

7. The smoke detector according to claim 1, wherein said number of emitters comprise a broad-band light source.

8. The smoke detector according to claim 7, wherein said broad-band light source is configured to emit light in the wavelength range between 350 nm and 1000 nm, especially between 350 nm and 700 nm.

9. The smoke detector according to claim 1, wherein said number of emitters-comprise at least one narrow-band light source (42).

10. The smoke detector according to claim 9, wherein said narrow-band light source is configured to emit in the UV and/or NIR range.

11. The smoke detector according to claim 1, wherein for each spectral range, two emitters are arranged in the detector chamber.

12. The smoke detector according to claim 1, comprising data registers for the respective plurality of spectral channels.

13. The smoke detector according to claim 1, wherein the smoke detector is configured to provide a control signal for the respective emitter.

14. A method for detecting smoke, the method comprising:
emitting light by at least one broadband emitter and/or a number of narrow range emitters into a detector chamber; and
sensing light scattered by smoke particles by a multi-spectral optical sensor.
